(19) United States
(12) Patent Application Publication
(10) Pub. No.: US 2008/0084143 A1
(43) Pub. Date: Apr. 10, 2008

(54) Detachable fastener assembly

(76) Inventor: Wen-Te Ho, Taichung (TW)

Correspondence Address: Hershkovitz & Associates, LLC, 2845 Duke Street, Alexandria, VA, 22314, US

(21) Appl. No.: 11/543,891

(22) Filed: Oct. 6, 2006

(51) Int. Cl. F16B 12/00

(52) U.S. Cl. 312/111

(57) ABSTRACT

A detachable fastener assembly includes a pin member and a nut. The pin member includes a base and a rotating pin. The rotating pin is mounted rotatably in the base and has a shank, a lever and a clamping tab. The shank has a protruding end. The lever is mounted on the shank to rotate the rotating pin. The clamping tab is formed on the protruding end of the shank. The nut has a receiving space, two ends, an inner surface and a flange. The flange is formed on the inner surface of the nut in one of the ends of the nut and corresponds to the clamping tab of the rotating pin. After the clamping tab is inserted into the nut and extends through the flange of the nut, the rotating pin is rotated to prevent the clamping tab from escaping from the nut.

### BACKGROUND OF THE INVENTION

1. Field of Invention

The present invention relates to a fastener assembly, and more particularly to a detachable fastener assembly that can combine detachably two objects together.

2. Description of the Related Art

Fasteners are generally used to combine two objects together, such as panels or the like. A conventional fastener comprises an insertable nut and a pin. The insertable nut is mounted in holes in the objects and has multiple resilient arms and a channel. The resilient arms are formed on the insertable nut. The channel is defined in the insertable nut. The pin extends through one of the objects, is inserted into the insertable nut and is mounted in the channel of the insertable nut. With the pin being inserted into the channel in the insertable nut, the insertable nut is expanded. Accordingly, the resilient arms of the insertable nut abut firmly with the holes in the objects and the insertable nut cannot escape from the holes even if a force of pulling back is applied to the insertable nut. So the fastener combines the objects securely together.

However, when a user combines the objects with the conventional fastener, the user must use a tool, such as a hammer to insert the pin into the channel of the insertable nut. After the objects are combined, the objects cannot be detached conveniently without using tools. Consequently, the conventional fastener is not suitable for collapsible furniture items, which needs to be assembled and detached easily.

To overcome the shortcomings, the present invention provides a detachable fastener assembly to mitigate or obviate the aforementioned problems.

### SUMMARY OF THE INVENTION

The primary objective of the present invention is to provide a detachable fastener assembly that can combine detachably two objects together.

The detachable fastener in accordance with the present invention comprises a pin member and a nut. The pin member comprises a base and a rotating pin. The base is hollow and has a bottom, a top, a first sidewall, a second sidewall and an opening. The first sidewall is flat and has a through hole defined through the first sidewall. The second sidewall has a through hole defined through the second sidewall and aligned with the through hole in the first sidewall. The opening is defined through the top of the base and extends in parallel with the first sidewall.

The rotating pin is mounted rotatably in the base and has a shank, a lever and a clamping tab. The shank has a mounting end and a protruding end. The mounting end is mounted in the through hole in the second sidewall. The protruding end extends through the through hole in the first sidewall and protrudes from the first sidewall. The lever is mounted on the shank and is received pivotally in the opening in the top of the base. The clamping tab is formed on the protruding end of the shank.

The nut is detachably combined with the pin member and has a receiving space, two ends, an inner surface, an outer surface and a flange. The receiving space is defined through the nut. The flange is formed on the inner surface of the nut in one of the ends of the nut and corresponds to and selectively abuts with the clamping tab of the rotating pin.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a detachable fastener assembly in accordance with the present invention;

FIG. 2 is a top view in partial section of the pin member of the detachable fastener assembly in FIG. 1;

FIG. 3 is an exploded perspective view of the detachable fastener assembly in FIG. 1 being attached to two objects; and

FIG. 4 is an operational top view in partial section of the detachable fastener assembly in FIG. 1.

### DETAILED DESCRIPTION OF THE INVENTION

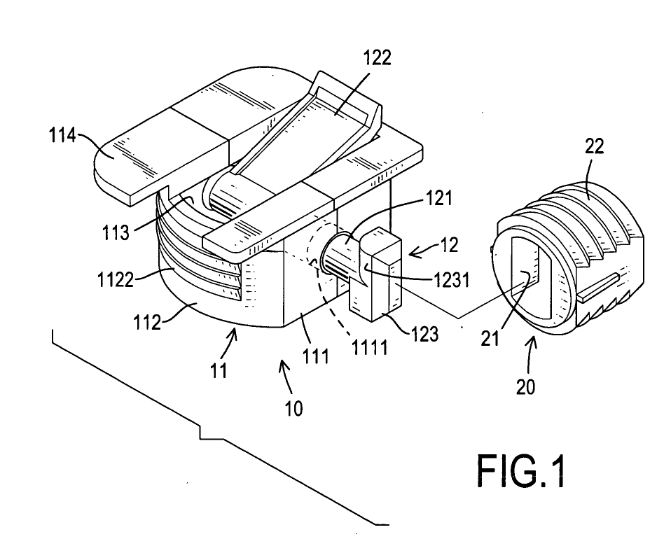

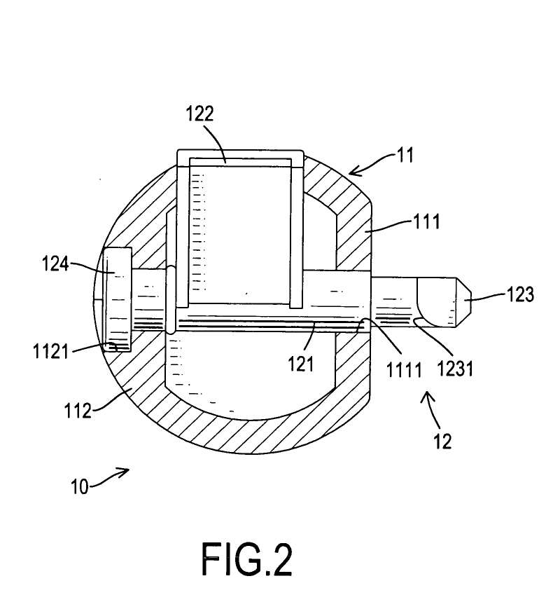

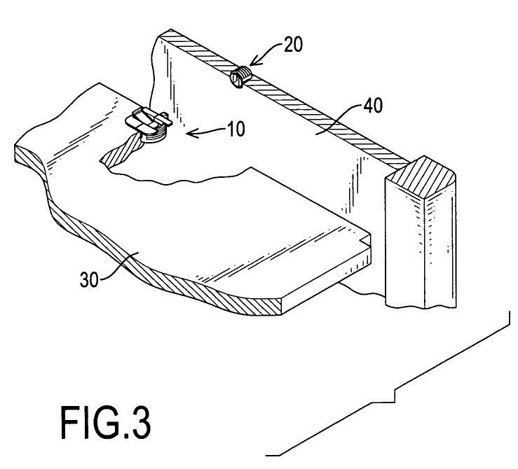

With reference to FIGS. 1, 2 and 3, a detachable fastener assembly in accordance with the present invention is used to detachably combine a first object (30) and a second object (40) together and comprises a pin member (10) and a nut (20). The pin member (10) is mounted in the first object (30) near an edge of the first object (30) and comprises a base (11) and a rotating pin (12). The base (11) is hollow, is mounted in the first object (30) and has a top, a first sidewall (111), a second sidewall (112) and an opening (113) and may have at least one flange (114). The first sidewall (111) is flat, corresponds to the edge of the first object (30) and has a through hole (1111) defined through the first sidewall (111). The second sidewall (112) is curved and has a through hole (1121) and multiple ridges (1122). The through hole (1121) of the second sidewall (112) is defined through the second sidewall (112) and aligned with the through hole (1111) in the first sidewall (111). The ridges (1122) are formed on the second sidewall (112) to abut securely with the first object (30). The opening (113) is defined through the top of the base (11) and extends in parallel with the first sidewall (111). The at least one flange (114) is formed on the top of the base (11) to keep the base (11) in a suitable position.

The rotating pin (12) is mounted rotatably in the base (11) and has a shank (121), a lever (122) and a clamping tab (123) and may have a mounting tab (124). The shank (121) has a mounting end and a protruding end. The mounting end of the shank (121) is mounted in the through hole (1121) in the second sidewall (112). The protruding end of the shank (121) extends through the through hole (1111) in the first sidewall (111) and protrudes from the first sidewall (111). The lever (122) is mounted on the shank (121) and is received pivotally in the opening (113) in the top of the base (11) to rotate the rotating pin (12). The clamping tab (123) is formed on the protruding end of the shank (121) and has two sides and two curved faces (1231). Each one of the curved faces (1231) of the clamping tab (123) is defined on one of the sides of the clamping tap (123), faces the first sidewall (111) of the base (11) and is inverse relative to the other curved face (1231) of the clamping tab (123). A distance is defined between the first sidewall (111) of the base (11) and the clamping tab (123) of the rotating pin (12). The mounting tab (124) is formed on the mounting end of the shank (121) to prevent the mounting end from escaping from the mounting hole (1121) in the second sidewall (112).

The nut (20) is plastic, is mounted in the second object (40) and has a receiving space, two ends, an inner surface, an outer surface and a flange (21) and may have multiple ridges (22). The receiving space is defined through the nut (20) for receiving the clamping tab (123) of the rotating pin (12). The flange (21) is formed on the inner surface of the nut (20) in one of the ends of the nut (20), corresponds to the clamping tab (123) of the rotating pin (12) and has an inner face and a thickness. The inner face of the flange (21) faces the second object (40). The thickness of the flange (21) is slightly larger than the distance between the first sidewall (111) of the base (11) and the clamping tab (123) of the rotating pin (12). The ridges (22) are formed on the outer surface of the nut (20) to abut securely with the second object (40).

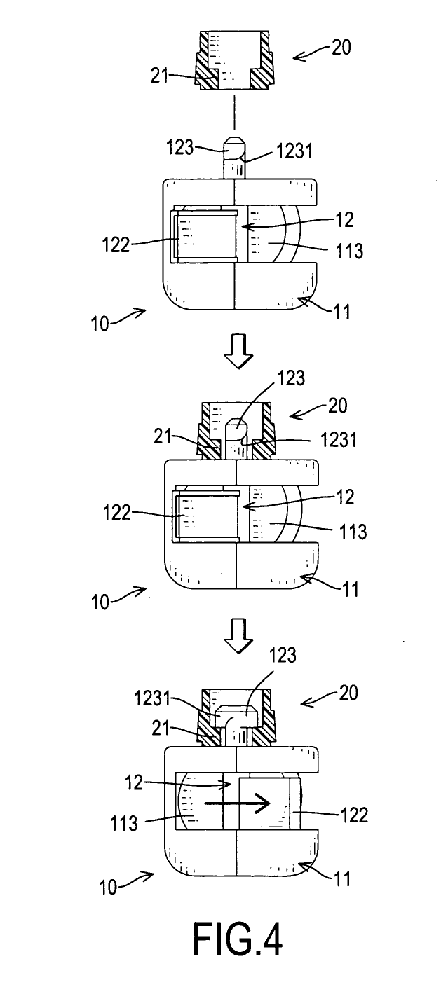

With further reference to FIG. 4, when the first and second objects (30, 40) are combined together, the clamping tab (123) of the rotating pin (12) is inserted into the nut (20) and extends through the flange (21) of the nut (20). Then the rotating pin (12) is rotated by pivoting the lever (122) of the rotating pin (12) to make the clamping tab (123) abutting with the flange (21) and prevent the clamping tab (123) from escaping from the nut (20). When the rotating pin (12) is rotated, the curved faces (1231) of the clamping tab (123) slide over the inner face of the flange (21) of the nut (20) and the flange (21) of the nut (20) is clamped tightly between the clamping tab (123) of the rotating pin (12) and the first sidewall (11) of the base (11). Consequently, the first and second objects (30, 40) are combined together and can be detached conveniently by reversely rotating the rotating pin (12). When the detachable fastener is used in a collapsible furniture item, the pin member (10) and the nut (20) are preinstalled in components of a collapsible furniture item. Accordingly, the components of the collapsible furniture item can be combined conveniently together without using tools.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A detachable fastener assembly comprising
a pin member comprising
a base being hollow and having
a bottom;
a top;
a first sidewall being flat and having
a through hole being defined through the first sidewall;
a second sidewall having
a through hole being defined through the second sidewall and aligned with the through hole in the first sidewall; and
an opening being defined through the top of the base and extending in parallel with the first sidewall; and
a rotating pin being mounted rotatably in the base and having
a shank having
a mounting end being mounted in the through hole in the second sidewall; and
a protruding end extending through the through hole in the first sidewall and protruding from the first sidewall;
a lever being mounted on the shank and received pivotally in the opening in the top of the base; and
a clamping tab being formed on the protruding end of the shank; and
a nut being detachably combined with the pin member and having
a receiving space being defined through the nut;
two ends;
an inner surface;
an outer surface; and
a flange being formed on the inner surface of the nut in one of the ends of the nut and corresponding to and selectively abutting with the clamping tab of the rotating pin.

2. The detachable fastener assembly as claimed in claim 1, wherein
the clamping tab of the rotating pin has two sides and two curved faces; and
each one of the curved faces of the clamping tab is defined on one of the sides of the clamping tap, faces the first sidewall and is inverse relative to the other curved face of the clamping tab.

3. The detachable fastener assembly as claimed in claim 2, wherein
a distance is defined between the first sidewall of the base and the clamping tab of the rotating pin; and
the flange of the nut has a thickness slightly larger than the distance between the first sidewall of the base and the clamping tab of the rotating pin

4. The detachable fastener assembly as claimed in claim 3, wherein
the nut further has multiple ridges defined on the outer surface of the nut.

5. The detachable fastener assembly as claimed in claim 4, wherein
the base further has multiple ridges formed on the second sidewall of the base.

6. The detachable fastener assembly as claimed in claim 5, wherein
the base further has at least one flange formed on the top of the base.

7. The detachable fastener assembly as claimed in claim 6, wherein
the rotating pin further has a mounting tab formed on the mounting end of the shank.

8. The detachable fastener assembly as claimed in claim 7, wherein
the second sidewall of the base is curved.

9. The detachable fastener assembly as claimed in claim 1, wherein
the nut further has multiple ridges defined on the outer surface of the nut.

10. The detachable fastener assembly as claimed in claim 1, wherein
the base further has multiple ridges formed on the second sidewall of the base.

11. The detachable fastener assembly as claimed in claim 1, wherein
the base further has at least one flange formed on the top of the base.

12. The detachable fastener assembly as claimed in claim 1, wherein
the rotating pin further has a mounting tab formed on the mounting end of the shank.

13. The detachable fastener assembly as claimed in claim 1, wherein
the second sidewall of the base is curved.
